(19) United States
(12) Patent Application Publication
(10) Pub. No.: US 2024/0078003 A1
(43) Pub. Date: Mar. 7, 2024

(54) INFORMATION PROCESSING APPARATUS, METHOD OF CONTROLLING THE SAME, AND STORAGE MEDIUM

(71) Applicant: Canon Kabushiki Kaisha, Tokyo (JP)

(72) Inventor: KOICHI YAMAMOTO, Kanagawa (JP)

(21) Appl. No.: 18/457,530

(22) Filed: Aug. 29, 2023

(30) Foreign Application Priority Data
Sep. 6, 2022 (JP) 2022-141515

(51) Int. Cl. G06F 3/04847; G06F 40/143

(52) U.S. Cl. CPC G06F 3/04847; G06F 40/143

(57) ABSTRACT

An information processing apparatus sets, to visible, a display attribute of one UI screen among a plurality of UI screens arranged in multiple layers in a web page, and set, to invisible, the display attribute of the other UI screens, and controls to display, on a display unit, a UI screen among the plurality of UI screens that has the display attribute set to visible by the setting unit. In response to an instruction to switch a UI screen displayed on the display unit, the information processing apparatus changes the display attribute of the UI screen among the plurality of UI screens displayed before switching, from visible to invisible, and changes the display attribute of a UI screen displayed after switching, from invisible to visible.

### BACKGROUND OF THE INVENTION

### Field of the Invention

The present invention relates to an information processing apparatus, a method of controlling the same, and a storage medium.

### Description of the Related Art

Apparatus equipped with a web browser is widely used, which displays a browsable web page by analyzing web content. For instance, in a communication terminal equipped with a web browser, it is possible to use an operation screen created with web content. By using the operation screen created with the web content, it becomes unnecessary to install software dedicated for displaying the operation screen. In addition, it is possible to designate a layer in the web content and thus the operation screen created with the web content can be arranged in a plurality of layers. Japanese Patent Laid-Open No. 2000-347645 discloses a technology in which, in a case where image content such as a menu bar on a web page is displayed on an upper layer from the web content that is currently being viewed, the menu bar is made transparent to prevent the web content from being hidden by the menu bar.

In a case where there are a plurality of operation screens created with web content, the plurality of operation screens are each arranged on different web pages. In this case, different web pages are accessed every time transition of operation screen occurs, and thus it is necessary to access different URLs for each transition of the operation screen. For this reason, processing of obtaining web content or processing of analyzing the obtained web content is performed for each transition of operation screen, and then transition of operation screen takes time. This may decrease usability of a user, particularly in a case where resources (in particular, communication resources) of a communication terminal equipped with the web browser are not sufficient.

### SUMMARY OF THE INVENTION

The present invention provides a technology that makes it possible to speed up transition of UI screens provided by a web page.

According to one aspect of the present invention, there is provided an information processing apparatus comprising: a setting unit configured to set, to visible, a display attribute of one UI screen among a plurality of UI screens arranged in multiple layers in a web page, and set, to invisible, the display attribute of the other UI screens; and a display control unit configured to control to display, on a display unit, a UI screen among the plurality of UI screens that has the display attribute set to visible by the setting unit, wherein in response to an instruction to switch a UI screen displayed on the display unit, the setting unit changes the display attribute of the UI screen among the plurality of UI screens displayed before switching, from visible to invisible, and changes the display attribute of a UI screen displayed after switching, from invisible to visible.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of a communication system according to a first embodiment.

FIG. 2A is a block diagram illustrating a functional configuration example of a communication terminal according to the first embodiment.

FIG. 2B is a block diagram illustrating a functional configuration example of a web server according to the first embodiment.

FIG. 3 is a diagram illustrating a description example of a file that constitutes a web page.

FIG. 4 is a diagram illustrating one example of a layer structure according to the first embodiment.

FIG. 5 is a flowchart used to explain an example of processing of a communication terminal according to the first embodiment.

FIGS. 6A and 6B are diagrams illustrating a description example of a file that constitutes a web page.

FIGS. 7A and 7B are flowcharts used to explain an example of processing of a communication terminal according to a second embodiment.

FIGS. 8A and 8B are flowcharts used to explain an example of processing of a communication terminal according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the first embodiment, an information processing apparatus equipped with a web browser transmits a request to a web server in displaying an operation screen, and receives web content constituting the operation screen from the web server. The information processing apparatus generates a plurality of operation screens overlapping in plural layers in accordance with the received web content. In a case where an operation screen is switched in response to a user operation, the information processing apparatus switches a display attribute (for instance, a visibility attribute or an Opacity attribute) of the operation screen described in the received web content to switch the operation screen. The information processing apparatus exemplified in the present embodiment has a communication function to communicate with the web server, and hereinafter, is referred to as a communication terminal.

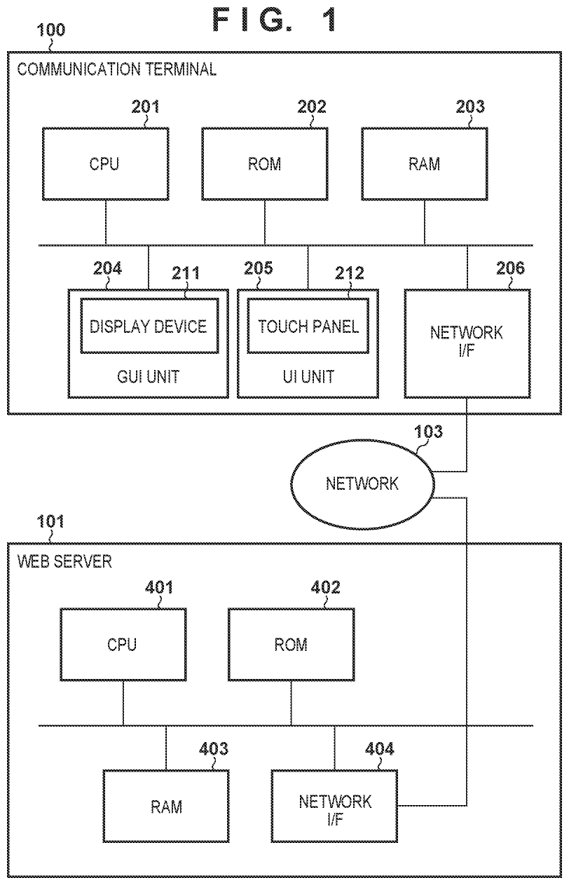

FIG. 1 is a diagram illustrating an example of a configuration of a communication system according to the first embodiment. A communication terminal 100 is connected communicatively to a web server 101, for instance, through a network 103. The communication terminal 100 obtains web content used to generate a user interface screen (hereinafter, referred to as a UI screen) from the web server 101 via the network 103. The communication terminal 100, which is a digital camera or a multi-function apparatus, for instance, displays the UI screen on a liquid crystal display unit (display device 211 in FIG. 1) by using web content obtained from the web server 101. In the present embodiment, for instance, the Internet, a wide area network (WAN), a local area network (LAN), and a combination of these can be used as the network 103. The web server 101 stores the web content, and distributes the web content to the communication terminal 100 as necessary. In the present embodiment, the web content includes HTML, CSS, JavaScript (trade name), an image file such as jpeg and png, and a moving image file such as mp4 and webm. Note that the CSS stands for Cascading Style Sheets.

FIG. 1 illustrates a block diagram illustrating an example of the hardware configuration of the communication terminal 100 according to the first embodiment. The CPU 201 is configured to control the communication terminal 100. Note that the CPU stands for a Central Processing Unit. A ROM 202 is a read only memory configured to store a program or a parameter that does not need to be changed. Note that the ROM stands for a Read Only Memory. The RAM 203 is a memory configured to temporarily store a program or data supplied from an external apparatus or the like, and can be performed reading and/or writing as necessary. The RAM stands for a Random Access Memory. A GUI unit 204 includes a display device 211, and displays the UI screen on the display device 211 to provide a user with a graphical user interface. The UI unit 205 is a user interface including a keyboard that receives an operation from the user to input data, an input device such as a physical button, a pointing device such as a mouse, or the like. The UI unit 205 includes a touch panel 212 arranged as overlapping on the display device 211. A network interface 206 is configured to connect the communication terminal 100 to a network. Note that the communication terminal 100 may include a hard disk arranged in a fixed manner, a memory card, or the like. Alternatively, the communication terminal 100 may be configured to be connectable to a detachable external storage apparatus or the like, which includes a flexible disk (FD), an optical disk such as a compact disk (CD), a magnetic or optical card, an IC card, a memory card, or the like.

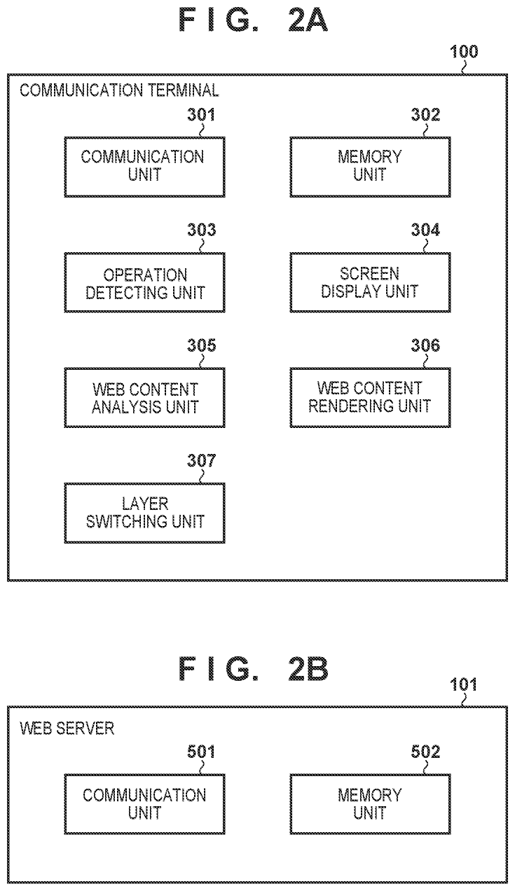

FIG. 2A is a block diagram illustrating a functional configuration example of the communication terminal 100 according to the present embodiment. Each function unit described below can be implemented, for instance, by causing the CPU 201 to execute a program stored in the ROM 202 or the RAM 203. In addition, part of or all of the function units described below may be implemented, for instance, with dedicated hardware such as an ASIC.

The communication unit 301 is configured to control communication performed by the communication terminal 100 via the network interface 206. A memory unit 302 is configured to store a specific operation performed to web content when the web content obtained from the web server 101 or the UI unit 205 is operated. An operation detecting unit 303 is configured to detect that the GUI unit 204 or the UI unit 205 is operated, and notifies a layer switching unit 307 of the detected operation information. The operation detecting unit 303 is also configured to perform determination processing of the detected operation type. A screen display unit 304 is configured to display the UI screen on a display screen of the GUI unit 204.

A web content analysis unit 305 is configured to analyze the web content obtained from the web server 101. A web content rendering unit 306 is configured to render the UI screen by a web page on the basis of a result of analysis of the web content by the web content analysis unit 305 and display the UI screen on the display device 211. The web content includes a plurality of UI screens in a form of a plurality of layers in one web page. Below, description will be made using an operation screen that is one example of the UI screen. The web content analysis unit 305 and the web content rendering unit 306 are configured to render and display an operation screen in accordance with a visibility attribute or an opacity attribute set for the operation screen of each layer. The layer switching unit 307 is configured to change a value of the display attribute (a visibility attribute or an opacity attribute) of the operation screen generated by the web content, in response to an operation input from the GUI unit 204 or the UI unit 205 to the operation screen.

Returning to FIG. 1, description will be made of an example of the hardware configuration of the web server 101 according to the first embodiment. A CPU 401 is configured to control the web server 101. A ROM 402 is a read only memory, and configured to store a program and a parameter that do not need to be changed. A RAM 403 is a memory to which reading and/or writing can be performed as necessary, and configured to temporarily store a program or data supplied from an external apparatus or the like. A network interface 404 is configured to connect the web server 101 to a network.

FIG. 2B is a block diagram illustrating a functional configuration example of the web server 101 according to the first embodiment. A communication unit 501 is configured to control communication performed by the communication terminal 100 via the network interface 404. Web content is stored in a memory unit 502. For instance, the communication unit 501 transmits, to the communication terminal 100, the web content (operation screen) stored in the memory unit 502.

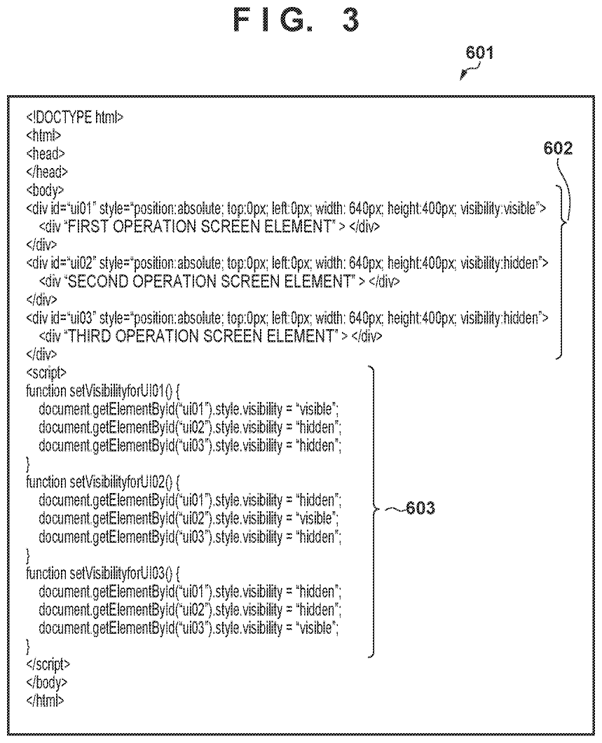

FIG. 3 is a diagram illustrating a description example of web content 601 distributed by the web server 101 to the communication terminal 100. According to the description 602 in FIG. 3, a plurality of operation screens are arranged at the same position on one web page in a plurality of layers. That is, a plurality of operation screens are arranged on one web page in multiple layers. Each of the plurality of operation screens is identified by an id element (ui01, ui02, ui03). In addition, JavaScript (trade name) processing for switching display attributes for each id is described between <script> and </script> (description 603). The display attribute includes a first display attribute in which a visible operation screen is turned into an active state and an invisible operation screen is turned into an inactive state, and also includes a second display attribute in which visibility is changed while the active state of the operation screen is kept. Although detail of each of the display attributes will be described later, the first display attribute includes, for instance, the visibility of CSS, and the second display attribute includes, for instance, the opacity of CSS. Furthermore, in order to achieve a layered structure, the same absolute value is designated to the position attribute of CSS for each of the operation screens.

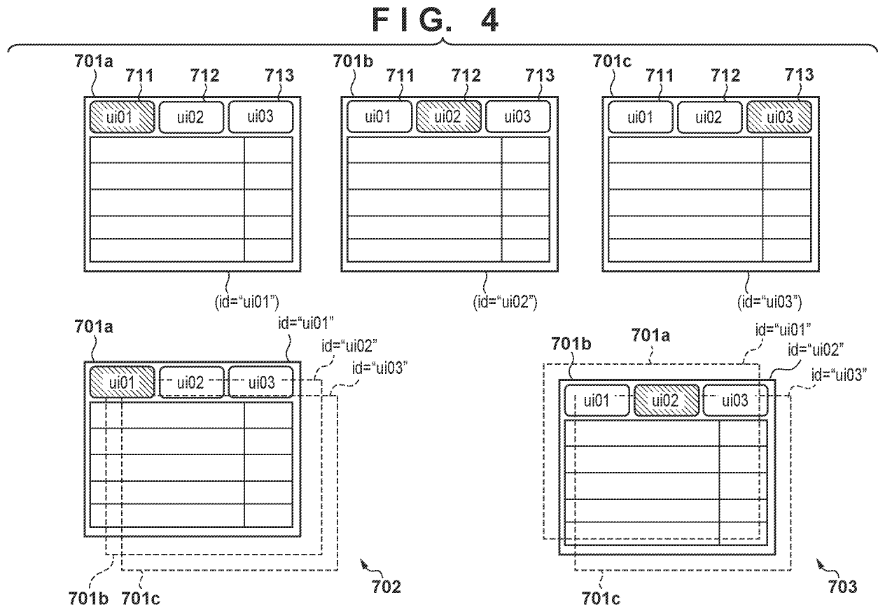

FIG. 4 is a diagram illustrating an example of display of operation screens by the screen display unit 304. The operation screens illustrated in FIG. 4 are examples in which the screen display unit 304 displays a web page on a display screen of the GUI unit 204 on the basis of a result of analysis of the web content 601 by the web content analysis unit 305. Each of operation screens 701a to 701c in FIG. 4 is an example of each of the plurality of operation screens defined by the web content 601. The operation screen 701a, the operation screen 701b, the operation screen 701c are the example of display of the operation screen respectively defined by id=“ui01,” id=“ui02,” id=“ui03.”

A display state 702 is an example in which the operation screen 701a is displayed in a web page including the operation screens 701a to 701c being overlapped as a plurality of layers. In the display state 702, a square with the solid line indicates a layer in a visible state (Visibility=1), and a square with the dotted line indicates a layer in an invisible state (Visibility=0). For instance, in the display state 702, the layer of the operation screen 701a defined by id=“ui01” is in a visible state, and the layers of the operation screens 701b and 701c defined by id=“ui02” and id=“ui03” are in an invisible state. Thus, the operation screen displayed by the screen display unit 304 looks as if only the operation screen 701a defined by id=“ui01” is displayed. The display state 703 is an example in which the operation screen 701b is displayed in a web page including the operation screens 701a to 701c being overlapped as a plurality of layers. In the display state 703, the layer of the operation screen defined by id=“ui02” is in the visible state, and the layers of the operation screens defined by id=“ui01” and id=“ui03” are in the invisible state. Thus, the operation screen displayed by the screen display unit 304 looks as if only the operation screen 701b defined by id=“ui02” is displayed.

Furthermore, in the present embodiment, when a user operation is performed to a region 711 (ui01 button), a region 712 (ui02 button), and a region 713 (ui03 button) of the operation screen, switching of operation screens is performed. When the operation detecting unit 303 detects a user operation to either the region 711 or the region 712, the layer switching unit 307 switches the visible states of layers. For instance, when an operation screen of ui01 is displayed as in the display state 702 and an operation is performed to the region 712 (ui02 button) of the operation screen, the layer switching unit 307 performs an operation of making the operation screen of ui02 visible and making the other operation screens invisible. Through this processing, the display state 703 is obtained. As described above, by setting a value in the display attribute, visible and invisible of the operation screen can be switched. In a case where visible and invisible are switched by the first display attribute, an operation screen in an invisible state turns into an inactive state, and an operation item of this operation screen turns into disabled. On the other hand, in a case where visible and invisible are switched by the second display attribute, an operation screen in an invisible state is kept in the active state. That is, the operation item of an operation screen that is invisible is kept in the enabled state.

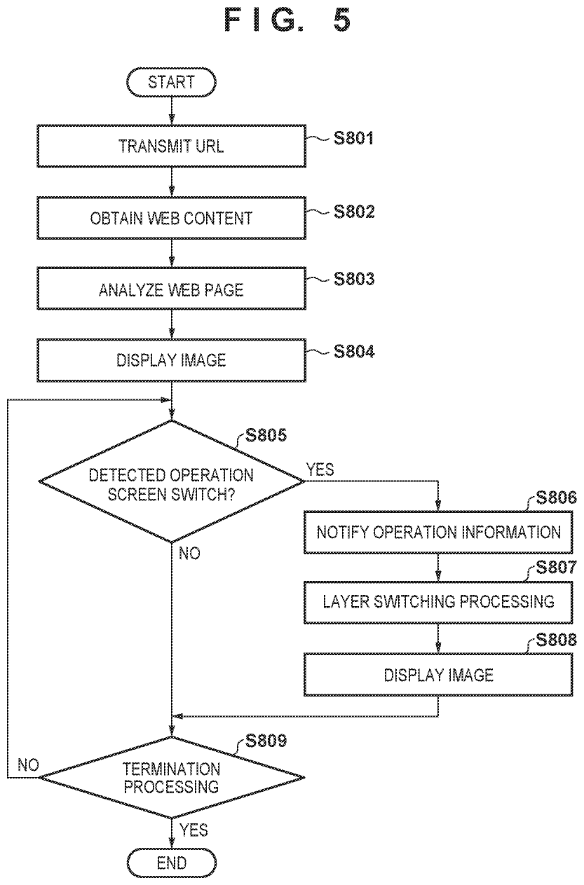

FIG. 5 is a flowchart used to explain a flow of processing of the communication terminal 100 according to the present embodiment. A user who uses the communication terminal 100 activates an operation screen using application, thereby processing of this flowchart starts. The operation screen using application is an application that displays an operation screen on the display device 211 and receives a user operation.

In S801, the communication unit 301 transmits, to the web server 101 serving as an external apparatus, a URL at which web content for displaying an operation screen is arranged. In S802, the communication unit 301 obtains, from the web server 101, the web content corresponding to the URL transmitted in S801, and stores the web content in the memory unit 302. In the present embodiment, description will be made on the assumption that the web content 601 illustrated in FIG. 3 is obtained from the web server 101. In S803, the web content analysis unit 305 analyzes the web content 601 stored in the memory unit 302 in S802, and the web content rendering unit 306 renders the web content (operation screen) on the basis of a result of the analysis. In S804, the screen display unit 304 performs display control in which the content rendered by the web content rendering unit 306 in S803 is displayed on the display device 211 of the GUI unit 204. For instance, among the plurality of operation screens arranged in multiple layers in one web page, the display attribute of one operation screen is set to visible, and the display attributes of the other operation screens are set to invisible, in accordance with the description 602 in FIG. 3. With the display control by the screen display unit 304, the operation screen of which display attribute is set to visible among the plurality of operation screens is displayed on the display unit. In the present example, only the operation screen of id=“ui01” has the visibility attribute set to be “visible” in the description 602 of the web content 601, and then the operation screen 701a is displayed as illustrated in the display state 702 in FIG. 4.

In S805, the operation detecting unit 303 detects a user operation to the GUI unit 204 or the UI unit 205, and determines whether or not an instruction is given to switch operation screens (layers). In a case where it is determined that the instruction to switch operation screens is given (YES in S805), the processing proceeds to S806. In S806, the operation detecting unit 303 notifies the layer switching unit 307 of operation information instructing to switch operation screens. On the other hand, in a case where it is determined that the instruction to switch operation screens is not given (NO in S805), the processing proceeds to S809. As for operations performed to the operation screen, the operation detecting unit 303 can detect two different types of user operations that includes a first operation using, as operation information, coordinate information indicating an operation position on the web page, and a second operation using operation information stored in the memory unit 302 in association with an operation input.

The first operation (hereinafter, referred to as coordinate operation) obtains operation information with respect to a touch panel operation to the GUI unit 204. The operation detecting unit 303 detects that a touch panel of the GUI unit 204 is operated, and outputs information indicating the touch position (coordinates) as click=(x, y). In a case where click=(x, y) obtained through the coordinate operation is a position corresponding to any of the regions 711 to 713 of the operation screen displayed on the display screen of the GUI unit 204, the operation detecting unit 303 determines that an instruction to switch layers is given. In a case where it is determined that an instruction to switch layers is given (YES in S805), the processing proceeds to S806, and the layer switching unit 307 is notified of the touch position (click=(x, y)) as the operation information.

The second operation (hereinafter, referred to as specific operation) obtains operation information with respect to the operation to the UI unit 205. The operation detecting unit 303 detects that the UI unit 205 is operated, and searches the memory unit 302 with the detected operation content. In a case where operation content that matches the detected operation content is stored in the memory unit 302, the operation detecting unit 303 reads out, from the memory unit 302, operation information stored in association with the operation content, and outputs it. In a case where operation content that matches the detected operation content is not stored in the memory unit 302, it is determined that no specific operation is detected.

For instance, in a case where the right-arrow key of the physical button on the UI unit 205 is operated, the operation detecting unit 303 searches for the right-arrow key in the memory unit 302. In the present embodiment, processing content (operation information) corresponding to the current display state are stored in the memory unit 302 as processing for the right-arrow key of the physical button of the UI unit 205. More specifically, run_setVisiblityforUI02( ) is stored in association with the right-arrow key in a case where id of the operation screen being displayed is 01; run_setVisiblityforUI03( ) is stored in association with the right-arrow key in a case where id of the operation screen being displayed is 02; and run_setVisiblityforUI01( ) is stored in association with the right-arrow key in a case where id of the operation screen being displayed is 03. The processing described above is used to switch layers. Thus, when determining that an instruction to switch layers is given through operation with the right-arrow key (YES in S805), the operation detecting unit 303 notifies the layer switching unit 307 of, as the operation information, processing for the right-arrow key corresponding to the current display state in S806.

In S807, the layer switching unit 307 performs layer switching processing on the basis of the operation information received from the operation detecting unit 303. That is, in accordance with the operation information of the switching instruction, the layer switching unit 307 changes the display attribute of an operation screen among the plurality of operation screens displayed before switching, from visible to invisible, and changes the display attribute of an operation screen displayed after switching, from invisible into visible. For instance, in a case where click=(x, y), indicated in the operation information notified through the coordinate operation, corresponds to the region 712, the layer switching unit 307 fires setVisiblityforUI02( ) of the web content 601. In addition, for instance, in a case where the operation information notified through the specific operation is run_setVisiblityforUI02( ), the layer switching unit 307 fires setVisiblityforUI02( ) of the web content 601. When setVisiblityforUI02( ) is thus executed, the values of the visibility attributes of the operation screens of id=“ui01” and id=“ui03” turn into “hidden.” Furthermore, the value of the visibility attribute of the operation screen of id=“ui02” turns into “visible.”

In S808, the web content analysis unit 305 analyzes the web content on the basis of the value of the display attribute changed in S807, and the web content rendering unit 306 renders the web content. And then, the screen display unit 304 displays rendered content on the display screen of the GUI unit 204. In the example of processing described above, the display state of the screen display unit 304 makes transition from the display state 702 to the display state 703 in FIG. 4. This is because, among the operation screens specified in the web content 601, id=“ui02” is the only operation screen having a value of the visibility attribute set to “visible.” In this manner, the displayed operation screen is switched from the operation screen 701a of ui01 to the operation screen 701b of ui02.

In S809, the operation detecting unit 303 determines whether or not termination processing is performed. The termination processing represents a case where a user terminates the operation screen using application of the communication terminal 100 by using the GUI unit 204 or the UI unit 205. In a case where the termination processing is determined to be performed (YES in S809), the processing ends. In a case where the termination processing is determined not to be performed (NO in S809), the processing returns to S805, and the processing described above is repeated.

In this manner, according to the first embodiment, by changing a value of the attribute of web content, transition of operation screens can be implemented. This eliminates the need of performing processing for obtaining web content or analysis of the obtained web content every time the operation screen makes transition, which makes it possible to reduce the time required to transition the operation screens.

### Second Embodiment

The second embodiment includes, in addition to the first embodiment, deciding an operation type for operation on an operation screen in activating an operation screen using application, and performing layer switching processing in accordance with the operation type. The operation type includes the coordinate operation and the specific operation described in the first embodiment. The hardware configuration and the functional configuration of the communication terminal 100, and the system configuration according to the second embodiment are similar to those in the first embodiment (FIG. 1, FIG. 2A, and FIG. 2B). Furthermore, the hardware configuration and the functional configuration of the web server 101 are also identical to those in the first embodiment (FIG. 1, FIG. 2A, and FIG. 2B). According to the present embodiment, it is possible to switch operation screens in the coordinate operation or the specific operation and also, in the specific operation, transition the operation screens at a speed higher than that in the first embodiment.

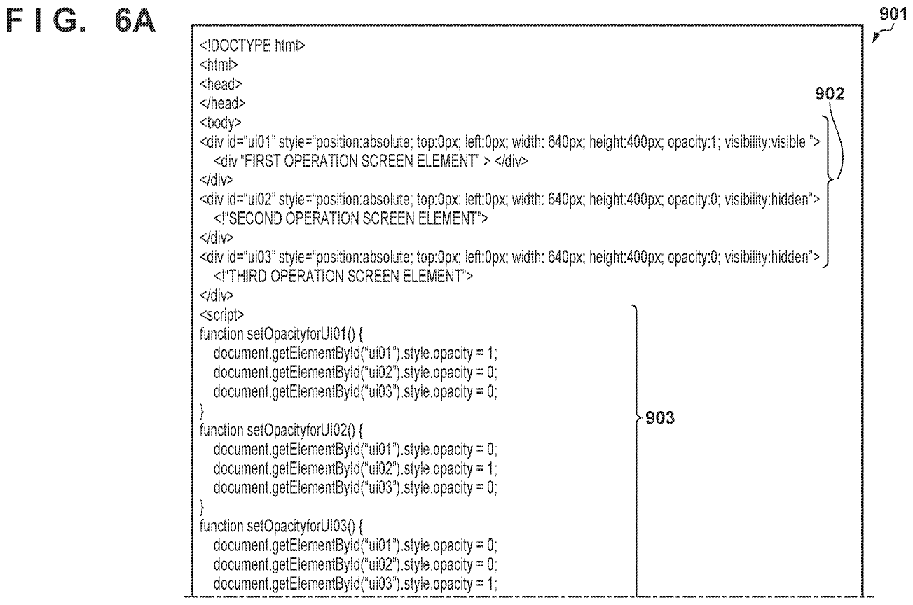

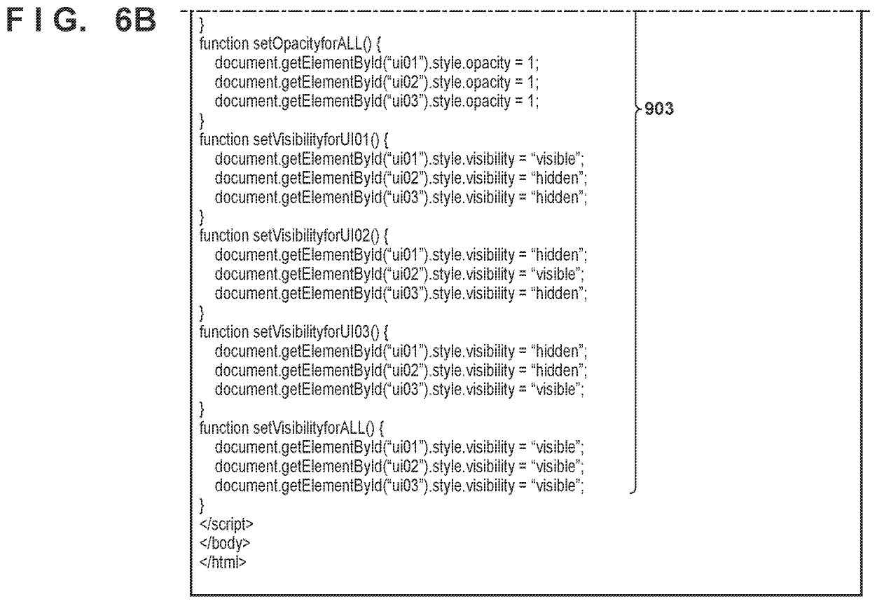

FIGS. 6A and 6B are diagrams illustrating a description example of web content according to the second embodiment. As with the web content 601, web content 901 describes a plurality of (three) operation screens created with web content in one web page. Each of the operation screens may be identified by an id element. In addition, JavaScript (trade name) processing for switching attributes for each of the ids is described in <script> (description 903) of the web content 901. The attribute as used herein means the opacity and the visibility of CSS in this example. In addition, in order to achieve a layer structure, as with the description 602 of the web content 601, the position attribute of CSS for each of the operation screens is specified, in the description 902, to the same absolute value. Furthermore, in the description 902 of the web content 901, the visibility attribute and the opacity attribute are described in the attribute of each of the operation screens.

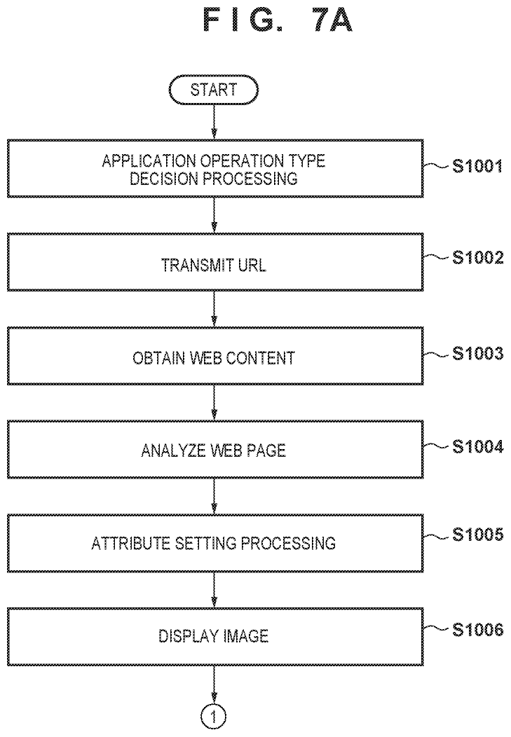

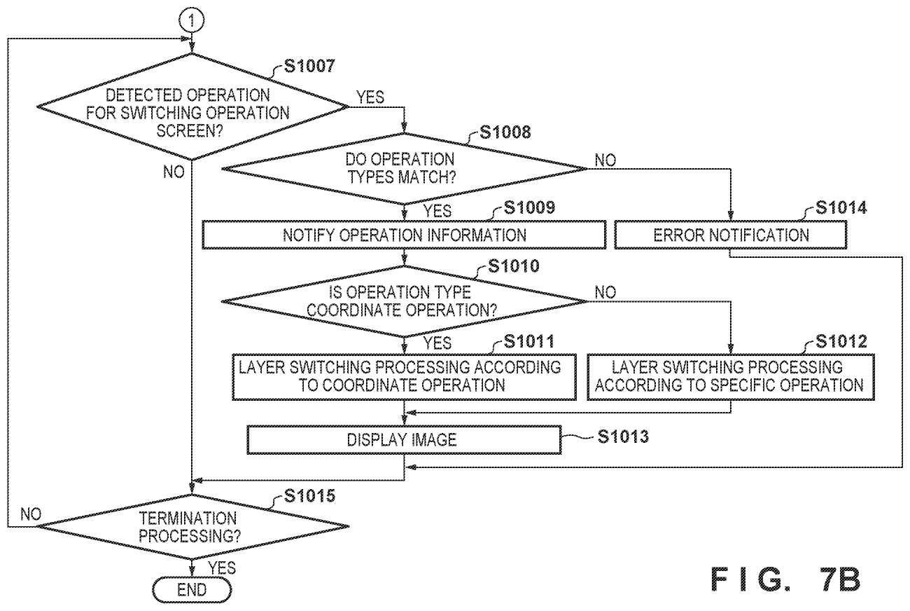

FIGS. 7A and 7B are flowcharts used to explain a flow of the processing of the communication terminal 100 according to the second embodiment. A user who uses the communication terminal 100 activates an operation screen using application, thereby starting processing of the flowcharts illustrated in FIGS. 7A and 7B.

Upon activation, by the user, of the operation screen using application using the GUI unit 204 or the UI unit 205, in S1001, the screen display unit 304 displays an operation type deciding screen on the GUI unit 204. The user can use the GUI unit 204 or the UI unit 205 to designate either the coordinate operation or the specific operation to be used as an operation type used to operate the operation screens. At this time, information indicating the designated operation type is stored in the memory unit 302 as operation type information.

In S1002, the communication unit 301 transmits, to the web server 101, a URL at which web content for displaying an operation screen is arranged. In S1003, the communication unit 301 obtains, from the web server 101, the web content corresponding to the URL transmitted in S1002, and stores the web content in the memory unit 302. The present embodiment will be described on the assumption that the web content 901 illustrated in FIGS. 6A and 6B is obtained from the web server 101. In S1004, the web content analysis unit 305 analyzes the web content stored in S1004, and the web content rendering unit 306 renders the web content (three operation screens of UI=01 to 03).

In S1005, the layer switching unit 307 sets display attributes (visibility and opacity) to a plurality of operation screens in accordance with the operation type designated in S1001. In a case where the coordinate operation is designated, the layer switching unit 307 sets all the opacity attributes of the plurality of operation screens to visible, and in S1011 described later, uses the visibility attribute to individually set visible and invisible of each of the operation screens. On the other hand, in a case where the specific operation is designated, the layer switching unit 307 sets values of all the visibility attributes of the plurality of operation screens to visible, and in S1012 described later, uses the opacity attribute to individually set visible and invisible of each of the operation screens. In the present embodiment, in a case where the coordinate operation is selected in S1001, the layer switching unit 307 executes a setOpacityforALL( ) processing of the web content 901, and sets a value of the opacity attribute of each of the operation screens to “1.” Furthermore, in a case where the specific operation is selected as the operation type in S1001, the layer switching unit 307 executes a setVisibilityforALL( ) processing of the web content 901, and sets a value of the visibility attribute of each of the operation screens to “visible.”

In S1006, the screen display unit 304 displays the operation screens rendered in S1004 on the display screen of the display device 211 of the GUI unit 204. At this time, among the operation screens described in the web content 901, the operation screen of id=“ui01” is the only operation screen having a value of the visibility attribute set to “visible” and having a value of the opacity attribute set to “1.” Thus, the display state of the operation screen displayed in S1006 is the display state 702 in FIG. 4.

In S1007, the operation detecting unit 303 detects a user operation to the GUI unit 204 or the UI unit 205, and determines whether or not an instruction is given to switch layers. The determination processing in S1007 is similar to that in the first embodiment (S805). In a case where it is determined that the instruction to switch layers is given (YES in S1007), the processing proceeds to S1008. On the other hand, in a case where it is determined that the instruction to switch layers is not given (NO in S1007), the processing proceeds to S1015.

In S1008, the operation detecting unit 303 determines whether or not the application operation type selected in S1001 is identical to an operation type (the coordinate operation or the specific operation) of the operation determined in S1007 as the instruction to switch layers. In a case where it is determined that the operation types are identical (YES in S1008), the processing proceeds to S1009, and in a case where it is determined that the operation types are different (NO in S1008), the processing proceeds to S1014. In S1009, the operation detecting unit 303 notifies the layer switching unit 307 of operation information determined to be the instruction giving an instruction to switch layers. The processing of S1009 is similar to that in the first embodiment (S806). In S1010, the layer switching unit 307 determines whether the type of operation of the switching instruction is the first operation (coordinate information) or the second operation (specific operation). In a case where the operation type is the coordinate operation (YES in S1010), the processing proceeds to S1011, and in a case where the operation type is the specific operation (NO in S1010), the processing proceeds to S1012.

In S1011, the layer switching unit 307 performs layer switching processing in accordance with the operation information (information on the coordinate operation) received from the operation detecting unit 303. For instance, in a case where the received click=(x, y) corresponds to the region 712, the layer switching unit 307 fires setVisiblityforUI02( ) of the web content 901. Through this process, the values of the visibility attributes of id=“ui01” and id=“ui03” of the web content 901 are set to “hidden,” and the value of the visibility attribute of id=“ui02” is set to “visible.” Furthermore, in the processing of S1011, only the values of the visibility attributes are changed, and the values of the opacity attribute of all the entire screens are kept as “1.” In this manner, the display state 702 is switched to the display state 703, and the screen being displayed is the operation screen 701b.

In S1012, the layer switching unit 307 performs layer switching processing in accordance with the operation information (instruction of processing according to the specific operation) received in S1008. For instance, in a case where the received operation information is run_setOpacityforUI02( ), the layer switching unit 307 fires setOpacityforUI02( ) of the web content 901. At this time, the values of the opacity attributes of id=“ui01” and id=“ui03” of the web content 901 are “0.” In addition, the value of the opacity attribute of id=“ui02” is “1.” Furthermore, in the processing in S1012, only the value of the opacity attribute is changed, and the value of the visibility attribute is kept as “visible.”

Processing of changing a value of the opacity attribute is faster than processing of changing a value of the visibility attribute, and hence, it is possible to transition operation screens at a higher speed. On the other hand, when “1” is set to values of the visibility attribute in all the operation screens, the operation screen at the upper layer obtains an operation processing in a case where the coordinate operation is performed. Thus, in a case where the coordinate operation is selected, the layer switching unit 307 changes a value of the visibility attribute to switch operation screens (S1011). For instance, assuming that the coordinate operation is selected in S1001 as the application operation type, and a setVIsibilityforALL( ) processing is executed in S1002. At this time, id=“ui01” is the only operation screen having a value of the visibility attribute set to “visible” and a value of the opacity attribute set to “1,” and hence, the screen displayed by the screen display unit 304 is the operation screen 701a. However, all the visibility attributes are set to “visible,” and hence, the operation screen of id=“ui03” at the uppermost layer obtains the operation of the coordinate operation, which makes it impossible to perform an operation to id=“ui01”. This leads to occurrence of unexpected operation for a user depending on the design of the operation screen. In a case of the specific operation, the operation stored in the memory unit 302 is executed, and thus, it is possible to avoid operating the upper-layer operation screen described above even in a case where a value of the opacity attribute, not a value of the visibility attribute, is changed.

In S1013, the web content analysis unit 305 analyzes the web content on the basis of the value of attribute changed in S1011 or S1012, and the web content rendering unit 306 renders the web content. And then, the screen display unit 304 displays rendered content on the display screen of the display device 211 of the GUI unit 204. In the present embodiment, content displayed by the screen display unit 304 makes transition from the display state 702 to the display state 703 in FIG. 4. This is because the operation screen, having a value of the visibility attribute set to “visible” and having a value of the opacity attribute set to “1”, is id=“ui02”. In this manner, the displayed operation screen is switched from the operation screen 701a of ui01 to the operation screen 701b of ui02.

In S1014, the operation detecting unit 303 performs error notification. The error notification as used herein means notifying that the application operation type selected in S1001 and the operation type detected in S1007 differ from each other, and thus, an error message may be displayed by the screen display unit 304.

In S1015, the operation detecting unit 303 determines whether or not termination processing is performed. The termination processing represents a case where a user uses the GUI unit 204 or the UI unit 205 to terminate the operation screen using application of the communication terminal 100. In a case where the termination processing is determined to be performed (YES in S1015), the processing ends. In a case where the termination processing is determined not to be performed (NO in S1015), the processing returns to S1007, and the processing described above is repeated.

With the second embodiment described above, the operation screen using application can be activated with the coordinate operation or the specific operation, and in the specific operation, it is possible to increase the speed of the transition of operation screens faster than the first embodiment.

Furthermore, in the second embodiment, the operation type is decided (S1001) after the operation screen using application is activated, however, the configuration is not limited to this. For instance, an operation type may be decided in accordance with an UI used by a user in giving an instruction to activate an operation screen using application. As a more specific example, in a case where a user operates the touch panel 212 to activate an operation screen using application, the application operation type is set to the coordinate operation on the assumption that the coordinate operation is continuously used. In contrast, in a case where a button operation of the UI unit 205 is used to activate an operation screen using application, the application operation type is set to the specific operation.

### Third Embodiment

The third embodiment includes, in addition to the first embodiment, performing layer switching processing in accordance with an operation type when the operation detecting unit 303 receives operation information. More specifically, in a case where the operation type is the coordinate operation, layers (operation screens) are switched by changing the value of Visibility, and in a case where the operation type is the specific operation, layers (operation screens) are switched by changing the value of Opacity. Furthermore, in the third embodiment, the hardware configuration and the software configuration of the communication terminal 100, and the system configuration diagram are also identical to those in the first embodiment (FIG. 1, FIG. 2A, and FIG. 2B). In addition, the hardware configuration and the software configuration diagram of the web server 101 are also identical to those in the first embodiment (FIG. 1, FIG. 2A, and FIG. 2B).

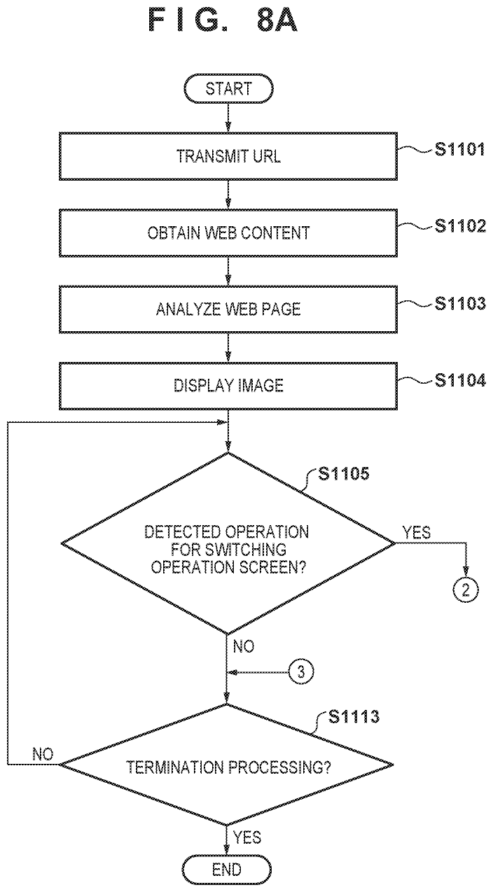

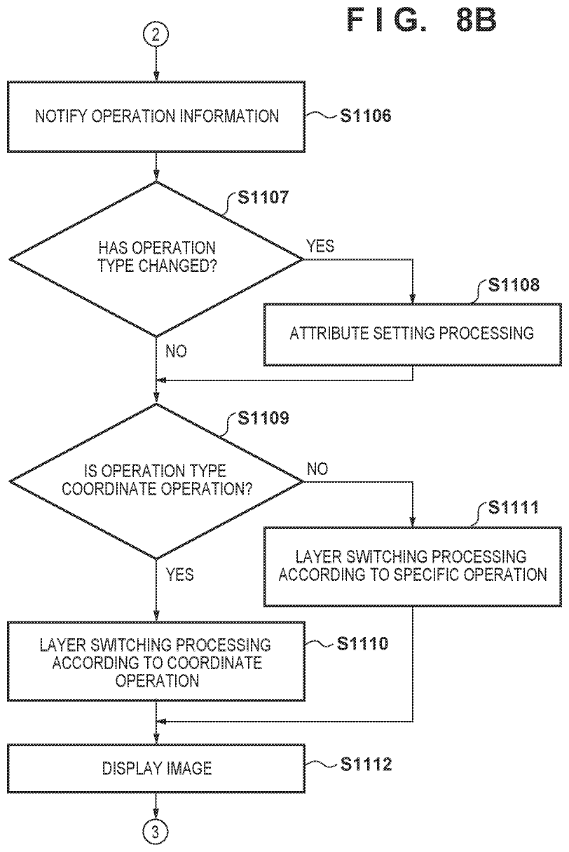

FIGS. 8A and 8B are flowcharts used to explain processing of a communication terminal 100 according to the third embodiment. This flowchart starts upon activation of the operation screen using application by a user who uses the communication terminal 100.

In S1101, the communication unit 301 transmits, to the web server 101, a URL at which web content of an operation screen is arranged. In S1102, the communication unit 301 obtains, from the web server 101, the web content corresponding to the URL transmitted in S1101, and stores it in the memory unit 302. The present embodiment will be described on the assumption that the web content 901 (FIGS. 6A and 6B) is obtained from the web server 101. In S1103, the web content analysis unit 305 analyzes the web content stored in the memory unit 302 in S1102, and the web content rendering unit 306 renders the web content on the basis of a result of the analysis. In S1104, the screen display unit 304 displays content rendered in S1103 on the display screen of the GUI unit 204. At this time, the displayed content is the display state 702 in FIG. 4. This is because, among the operation screens described in the web content 901, id=“ui01” is the only operation screen having a value of the visibility attribute set to “visible” and a value of the opacity attribute set to “1.”

In S1105, the operation detecting unit 303 determines whether or not an instruction to switch operation screens is given through the coordinate operation from the GUI unit 204 or the specific operation from the UI unit 205. In a case where an operation for switching operation screens through the coordinate operation or the specific operation is detected as a result of determination in S1105 (YES in S1105), the processing proceeds to S1106. In a case where the operation to switch operation screens is not detected (NO in S1105), the processing proceeds to S1113. Note that, in order to enable the operation detecting unit 303 to detect, in S1105, both the operation of switching through the coordinate operation and the operation of switching through the specific operation, the regions 711 to 713 are each provided at the same coordinate position between the operation screens 701a to 701c. This is because the operation of switching through the coordinate operation can be correctly detected even if display is switched only with the opacity attribute.

In S1106, the operation detecting unit 303 notifies the layer switching unit 307 of operation information determined to be the instruction giving an instruction to switch layers. In S1107, the layer switching unit 307 determines, on the basis of the notified operation information, whether or not the operation type is changed. For instance, the layer switching unit 307 determines whether or not the present operation type indicated by the notified operation information is identical to the previous operation type stored in the memory unit 302. In a case where the operation types differ as a result of determination (YES in S1107), the processing proceeds to S1108, and in a case where the operation types are identical (NO in S1107), the processing proceeds to S1109. In addition, in the present embodiment, the previous operation type is stored in the memory unit 302 at S1108. Thus, the previous operation type for the first time after activation of an application is not stored, however, at this case, the operation type is determined to be changed, and the processing proceeds to S1108.

In S1108, the layer switching unit 307 performs a preparation processing for switching layers due to the change of operation types. For instance, in a case where the operation type is determined to be changed from the coordinate operation to the specific operation, the layer switching unit 307 executes processing of setVisibilityforALL( ) of the web content 901. In addition, for instance, in a case where the operation type is determined to be changed from the specific operation to the coordinate operation, the layer switching unit 307 executes processing of setOpacityforALL( ) of the web content 901. Furthermore, in S1108, the layer switching unit 307 updates the previous operation type stored in the memory unit 302, with the operation type determined by the operation detecting unit 303.

In S1109, the processing branches depending on the detected operation type. In a case where the operation type is the coordinate operation (YES in S1109), the processing proceeds to S1110, and in a case where the operation type is the specific operation (NO in S1109), the processing proceeds to S1111. In S1110, the layer switching unit 307 performs layer switching processing in accordance with the notified operation information of the coordinate operation. The processing of S1110 is similar to that of S1011, and the layer switching unit 307 changes a value of the Visibility attribute to switch operation screens (layers). On the other hand, in S1111, the layer switching unit 307 performs layer switching processing in accordance with the notified operation information of the specific operation. The processing of S1111 is similar to that of S1012, and the layer switching unit 307 changes a value of the Opacity attribute to switch operation screens (layers).

In S1112, the web content analysis unit 305 analyzes the web content on the basis of the value of the attribute changed in S1110 or S1111, and the web content rendering unit 306 renders the web content on the basis of the result of the analysis. Then, the screen display unit 304 displays the rendered content on the display screen of the GUI unit 204. For instance, when an instruction is given through the coordinate operation to make switch into the operation screen of id=2, the value of the opacity attribute is set to “1” for all the layers. In addition, the value of the visibility attribute of a layer of id=2 is set to “visible,” and values of the visibility attribute of other layers are set to “hidden.” Thus, id=“ui02” is the only operation screen (layer) having a value of the visibility attribute set to “visible” and a value of the opacity attribute set to “1,” and the content displayed by the screen display unit 304 makes transition from the display state 702 to the display state 703 in FIG. 4.

In S1113, the operation detecting unit 303 determines whether or not an instruction to perform termination processing is given. The termination processing represents processing performed, for instance, in a case where a user uses the GUI unit 204 or the UI unit 205 to terminate the operation screen using application of the communication terminal 100. In a case where an instruction to perform the termination processing is determined to be given (YES in S1113), this processing ends. In a case where an instruction to perform the termination processing is determined not to be given (NO in S1113), the processing returns to S1105, and the processing described above is performed.

It should be noted that, in the third embodiment, in a case where switching of operation screens is performed through the coordinate operation, the subsequent input to the operation screen may be performed by either the coordinate operation or the specific operation. On the other hand, in a case where switching of operation screens is performed through the specific operation, the subsequent input to the operation screen is only accepted in a case where the input is performed through the specific operation, except for the instruction to switch operation screens. This is because, in a case of switching of operation screens performed through the specific operation, the values of the visibility attribute of operation screens of all the layers are set to “visible,” and hence, the operation is always detected as the coordinate operation performed to an upper layer. Note that, as described above, the instruction to switch operation screens may be given through either the coordinate operation or the specific operation.

In this manner, according to the third embodiment, it is possible to perform an operation with the coordinate operation even in a case where, after an application using an operation screen is activated, the operation type received by the operation detecting unit 303 changes while the application is being activated. In addition, in a case where an operation with the specific operation is performed, it is possible to speed up the transition of operation screens, as described in the second embodiment.

It should be noted that, in the first to third embodiments, the web content is arranged on the web server 101, however, the configuration is not limited to this. For instance, it may be possible to employ a mode in which web content is arranged in the communication terminal 100, and the communication terminal 100 obtains the web content arranged in the communication terminal 100 in processing of S801, S1004, and S1101.

Furthermore, in the first to third embodiments, description has been made such that it is possible to reduce the time for transition of the operation screens, in addition to this effect, it is possible to achieve an effect of reducing a processing load of the communication terminal 100. This makes it possible to reduce the time in which operations of other applications are interrupted.

According to each of the embodiments described above, it is possible to speed up the transition of UI screens provided by the web page.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-141515, filed Sep. 6, 2022, which is hereby incorporated by reference herein in its entirety.

What is claimed is:

1. An information processing apparatus comprising:
a setting unit configured to set, to visible, a display attribute of one UI screen among a plurality of UI screens arranged in multiple layers in a web page, and set, to invisible, the display attribute of the other UI screens; and
a display control unit configured to control to display, on a display unit, a UI screen among the plurality of UI screens that has the display attribute set to visible by the setting unit, wherein
in response to an instruction to switch a UI screen displayed on the display unit, the setting unit changes the display attribute of the UI screen among the plurality of UI screens displayed before switching, from visible to invisible, and changes the display attribute of a UI screen displayed after switching, from invisible to visible.

2. The information processing apparatus according to claim 1, wherein the web page is obtained from an external apparatus.

3. The information processing apparatus according to claim 1, wherein the display attribute includes a visibility attribute of CSS.

4. The information processing apparatus according to claim 1, further comprising:
a determination unit configured to determine whether a type of an operation that gives the instruction is a first operation using, as operation information, coordinate information indicating an operation position on the web page or a second operation using operation information stored, in association with an operation input, in a memory unit, wherein
in a case where the instruction is given through the first operation, the setting unit changes a first display attribute accompanied by turning a UI screen of invisible into an inactive state, and
in a case where the instruction is given through the second operation, the setting unit changes a second display attribute that changes visibility with keeping an active state of a UI screen.

5. The information processing apparatus according to claim 4, further comprising:
a selection unit configured to select either the first operation or the second operation as a type of operation for operating the UI screen; and
a notification unit configured to notify of an error in a case where the type of the operation determined by the determination unit does not match the type of the operation selected by the selection unit.

6. The information processing apparatus according to claim 4, further comprising:
a selection unit configured to select either the first operation or the second operation on a basis of a type of operation for activating application using the UI screen; and
a notification unit configured to notify of an error in a case where the type of the operation determined by the determination unit does not match the type of the operation selected by the selection unit.

7. The information processing apparatus according to claim 5, wherein
in a case where the selection unit selects the first operation, the setting unit sets the second display attribute to visible for all the plurality of UI screens, and uses the first display attribute to set visible or invisible of each of the UI screens, and
in a case where the selection unit selects the second operation, the setting unit sets the first display attribute to visible for all the plurality of UI screens, and uses the second display attribute to set visible or invisible of each of the UI screens.

8. The information processing apparatus according to claim 4, wherein
in a case where a type of an operation of a present instruction determined by the determination unit differs from a type of an operation of a previous instruction determined by the determination unit,
when the type of the operation of the present instruction is the first operation, the setting unit sets the second display attribute to visible for all the plurality of UI screens, and uses the first display attribute to set visible or invisible of each of the UI screens, and
when a type of operation of the present instruction is the second operation, the setting unit sets the first display attribute to visible for all the plurality of UI screens, and uses the second display attribute to set visible or invisible of each of the UI screens.

9. The information processing apparatus according to claim 4, wherein
the first display attribute is a visibility attribute of CSS,
the second display attribute is an opacity attribute of CSS,
the first operation is an operation using, as operation information, coordinate information indicating an operation position on a web page, and
the second operation is an operation using operation information stored, in association with an operation input, in the memory unit.

10. A method of controlling an information processing apparatus, comprising:
setting, to visible, a display attribute of one UI screen among a plurality of UI screens arranged in multiple layers in a web page, and setting, to invisible, the display attribute of the other UI screens; and
controlling to display, on a display unit, a UI screen among the plurality of UI screens that has the display attribute set to visible by the setting, wherein
in response to an instruction to switch a UI screen displayed on the display unit, the setting changes the display attribute of the UI screen among the plurality of UI screens displayed before switching, from visible to invisible, and changes the display attribute of a UI screen displayed after switching, from invisible to visible.

11. A non-transitory computer-readable storage medium storing a program used to cause a computer to execute a method of controlling an information processing apparatus, the method comprising:
setting, to visible, a display attribute of one UI screen among a plurality of UI screens arranged in multiple layers in a web page, and setting, to invisible, the display attribute of the other UI screens; and
controlling to display, on a display unit, a UI screen among the plurality of UI screens that has the display attribute set to visible by the setting, wherein
in response to an instruction to switch a UI screen displayed on the display unit, setting changes the display attribute of the UI screen among the plurality of UI screens displayed before switching, from visible to invisible, and changes the display attribute of a UI screen displayed after switching, from invisible to visible.
